(19) United States
(12) Patent Application Publication
(10) Pub. No.: US 2014/0184399 A1
(43) Pub. Date: Jul. 3, 2014

(54) REAR COLLISION WARNING ALERT SYSTEM AND METHOD

(71) Applicants: Kia Motors Corporation, Seoul (KR); Hyundai Motor Company, Seoul (KR)

(72) Inventors: Hyung Jun Lim, Yangpyeong (KR); Jong Chul Kim, Suwon (KR)

(73) Assignees: KIA MOTORS CORPORATION, Seoul (KR); HYUNDAI MOTOR COMPANY, Seoul (KR)

(21) Appl. No.: 14/045,146

(22) Filed: Oct. 3, 2013

(30) Foreign Application Priority Data
Dec. 31, 2012 (KR) 10-2012-0158606

(51) Int. Cl. G08G 1/16

(52) U.S. Cl. CPC G08G 1/167
USPC 340/435

(57) ABSTRACT

A system and method of generating a warning of a rear collision that includes setting, by a controller, a concern area around a vehicle and measuring, by a sensor, the position and distance of an approaching object. In addition, the controller is configured to store the position and distance of the approaching object and determine whether the path of the approaching object crosses the boundary of the concern area, using at least two or more stored positions and distances. The controller calculates a time-to-collision of the approaching object, when the path of the approaching object crosses the boundary of the concern area; and generates a warning which indicating the approaching object.

### CROSS-REFERENCE TO RELATED APPLICATION

This application claims priority to and the benefit of Korean Patent Application No. 10-2012-0158606 filed in the Korean Intellectual Property Office on Dec. 31, 2012, the entire contents of which are incorporated herein by reference.

### BACKGROUND

(a) Field of the Invention

The present invention relates to a system and a method of generating a warning of a rear collision. More particularly, the present invention relates to a system and a method of generating a warning of a rear collision which minimize the costs of additional parts.

(b) Description of the Related Art

Recently, devices or systems which promote safe driving by providing various items of information regarding the driving of vehicles or by warning a driver in vehicles have been developed. For example, a BSD (Blind Spot Detection) system is a system that detects vehicles in a rear using two radars mounted on the rear of a vehicle and detects an approaching vehicle in the dead zone in the rear and warns the driver of the approach. An LCA (Lane Change Assist) system is a system that promotes safe driving of a vehicle by detecting a vehicle approaching at a substantially high speed from behind and warning the driver of the approaching vehicle, and by warning the driver again when changing to a lane in which an approaching vehicle is traveling.

The BSD system generates a warning, when a TTC (time to collision) reaches a threshold value, in consideration of only the TTC between an approaching vehicle and the vehicle being driven based on the location of the vehicle approaching from behind.

However, common BSD systems have a possibility of generating unnecessary warnings, due to generating a warning based on only whether there is a vehicle approaching from behind and the TTC. For example, the systems may generate an unnecessary warning, including a possibility of generating warning based on only whether there is a vehicle approaching, regardless of the lane that the vehicle is being driven in.

The above information disclosed in this section is only for enhancement of understanding of the background of the invention and therefore it may contain information that does not form the prior art that is already known in this country to a person of ordinary skill in the art.

### SUMMARY

The present invention provides a system and a method of generating a warning of a rear collision having advantages of being able to prevent unnecessary warnings by generating warning based on the lane of an approaching vehicle and a TTC.

An exemplary embodiment of the present invention provides a method of generating a warning of a rear collision, which may include: setting a concern area around a vehicle being driven; measuring the position and distance of an approaching object; storing the position and distance of the approaching object and determining whether the path of the approaching object crosses the boundary of the concern area, using at least two or more stored positions and distances; calculating a TTC of the approaching object, when the path of the approaching object crosses the boundary of the concern area; and generating a warning indicating the approaching object.

The warning may be generated, depending on the TTC of the approaching object and the current distance of the approaching object. The warning may not be generated, when the angle formed by the path of the approaching object, which crosses the concern area, and the boundary of the concern area is a predetermined angle or less. In addition, the warning may not be generated, when the angle formed by the path of the approaching object, which crosses the concern area, and the boundary of the concern area is a predetermined angle or less. The method may further include determining whether conditions for performing the method of generating a warning of a rear collision are satisfied.

Another exemplary embodiment of the present invention provides a system for generating a warning of a rear collision, which may include a sensor that measures the position and distance of an approaching object; a warning unit that generates a warning indicating that there is the approaching object; and a control unit that operates the warning unit based on the measured position and distance of the approaching object, in which the control unit executes a series of instructions for performing the methods of generating a warning of a rear collision.

The sensor may be a BSD (Blind Spot Detection system) radar or an LCA (Lane Change Assist system) radar. The warning unit may be a speaker or a display that outputs a voice or image warning.

According to the system and the method of generating a warning of a rear collision of an exemplary embodiment of the present invention, it may be possible to prevent unnecessary warnings by generating a warning based on the path and the TTC of an approaching vehicle. In addition, according to the system and the method of generating a warning of a rear collision of an exemplary embodiment of the present invention, it may be possible to generate a warning of a rear collision without an increase in cost, due to using the components of the existing warning system in a vehicle.

### BRIEF DESCRIPTION OF THE DRAWINGS

FIG. 1 is an exemplary view illustrating the operational principle of a system for generating a warning of a rear collision according to an exemplary embodiment of the present invention;

FIG. 2 is an exemplary view illustrating warning by the system for generating a warning of a rear collision, based on an approach distance, according to an exemplary embodiment of the present invention;

FIG. 3 is an exemplary block diagram of the system for generating a warning of a rear collision according to an exemplary embodiment of the present invention;

FIGS. 4 to 6 are exemplary views showing an example of using the system for generating a warning of a rear collision according to an exemplary embodiment of the present invention; and

FIG. 7 is an exemplary flowchart illustrating a method of generating a warning of a rear collision according to an exemplary embodiment of the present invention.

Description of symbols

| | |
|---|---|
| 1: Concern vehicle | 2-9: Approaching object |
| 50: Sensor | 60: Control unit |
| 70: Warning unit | |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the following detailed description, only certain exemplary embodiments of the present invention have been shown and described, simply by way of illustration. As those skilled in the art would realize, the described embodiments may be modified in various different ways, all without departing from the spirit or scope of the present invention. Like reference numerals are given to like components throughout the specification. Throughout the specification, unless explicitly described to the contrary, the word “comprise” and variations such as “comprises” or “comprising,” will be understood to imply the inclusion of stated elements but not the exclusion of any other elements.

An exemplary embodiment of the present invention will hereinafter be described in detail with reference to the accompanying drawings.

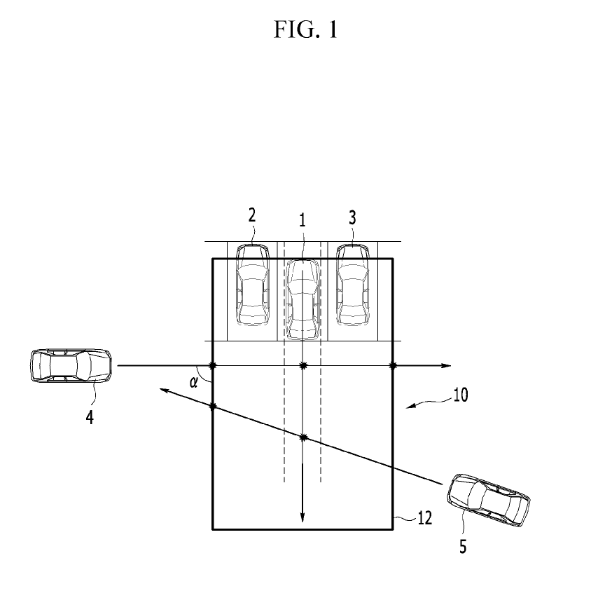

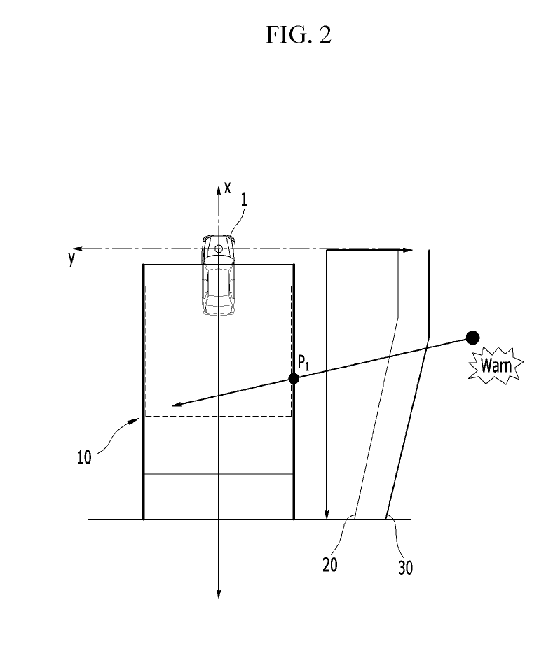

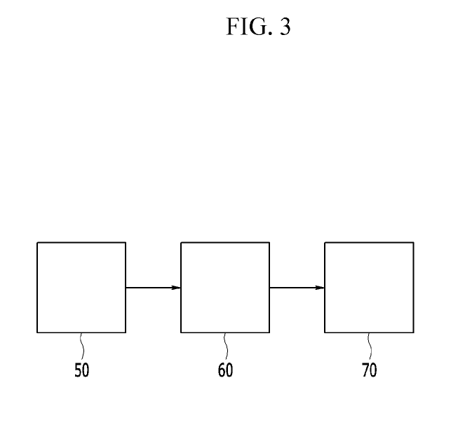

FIG. 1 is an exemplary view illustrating the operational principle of a system that generates a warning of a rear collision according to an exemplary embodiment of the present invention, FIG. 2 is an exemplary view illustrating warning by the system that generates a warning of a rear collision, based on an approach distance, according to an exemplary embodiment of the present invention, and FIG. 3 is an exemplary block diagram of the system that generates a warning of a rear collision according to an exemplary embodiment of the present invention.

A system that generates a warning of a rear collision according to an exemplary embodiment of the present invention may include a sensor 40 that measures the position and distance of an approaching object, a warning unit 70 that generates a warning indicating an approaching object, and a control unit 60 configured to operate the warning unit based on the information regarding the measured position and distance of the approaching object, in which the control unit 60 may be configured to execute a series of instructions for performing a method of generating a warning of a rear collision. The operation of the control unit 60 will be described below.

The sensor 40 may be a BSD (Blind Spot Detection system) radar or an LCA (Lane Change Assist system) radar and the warning unit 70 may be a speaker or a display configured to output a voice or image warning. Furthermore, since the system that generates a warning of a rear collision according to an exemplary embodiment of the present invention may use a BSD radar or an LCA radar, the system may generates a warning of a rear collision without an additional increase in cost.

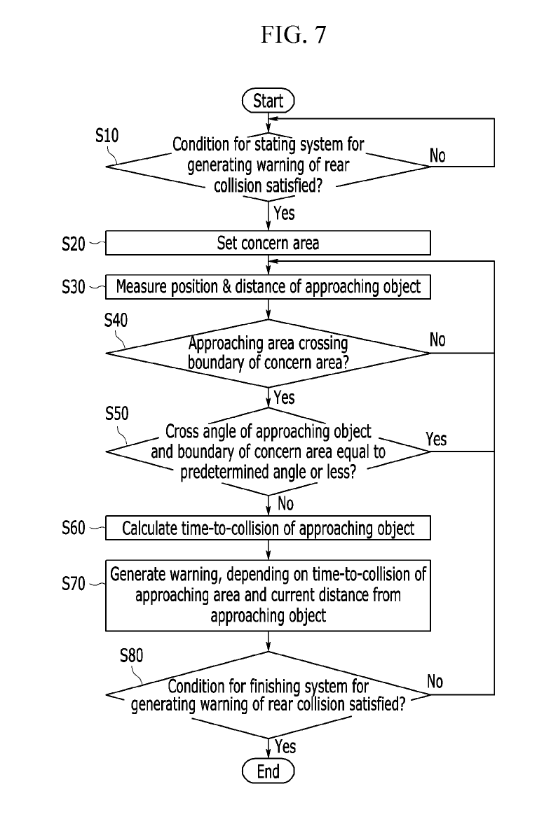

FIG. 7 is an exemplary flowchart illustrating a method of generating a warning of a rear collision according to an exemplary embodiment of the present invention. Hereinafter, a method of generating a warning of a rear collision according to an exemplary embodiment of the present invention is described with reference to FIGS. 1 to 3 and FIG. 7.

The control unit 60 may be configured to set a concern area 10 around a vehicle 1 (S20). The vehicle 1 equipped with the system that generates a warning of a rear collision according to an exemplary embodiment of the present invention, may be defined as a concern vehicle 1. The concern area 10 set around the concern vehicle 1, as shown in FIGS. 1 and 2, may be an area in which a risk of a collision of the concern vehicle 1 exists, and may be set in a rectangular area around the concern vehicle 1 and may include a straight boundary 12.

The control unit 60 may be configured to measure the position and distance of objects 4 and 5 approaching the concern vehicle 1 (S30). The position and distance of the objects 2 and 5 may be measured by the BSD radar or the LCA radar. In addition, the control unit 60 may be configured to store the position and distance of the approaching objects 4 and 5 and determine whether the paths of the approaching objects 4 and 5 cross the boundary 12 of the concern area, using at least two or more stored positions and distances (S40). The paths of the approaching objects 4 and 5 may be obtained, with respect to the concern vehicle 1, from a linear equation and two or more coordinates of the approaching objects 4 and 5. In other words, the paths of the approaching objects 4 and 5 may be calculated from the following linear equation.

(Y−Y1)/X−X1=(Y2−Y1)/(X2−X2)

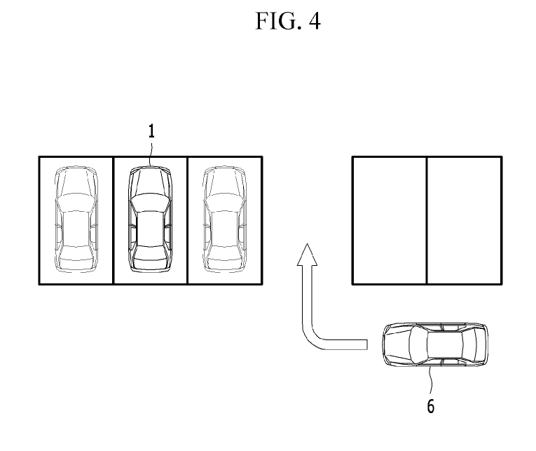

For example, the control unit 60 may not be configured to generate a warning of approach of an approaching vehicle 6, when there is a decreased possibility that the approaching vehicle 6 shown in FIG. 4 may collide with the concern vehicle 1, according to the path.

The control unit 60 may be configured to calculate the TTC (Time To Collision) of an approaching objects 4 and 5, when the paths of the approaching objects 4 and 5 cross the boundary 12 of the concern area (S60). The TTC of the approaching objects 4 and 5 may be obtained from two or more positions and distances of the approaching objects 4 and 5. Furthermore, the control unit 60 may be configured to generate a warning, indicating approaching objects 4 and 5, via the warning unit 70 (S70). The warning unit 70 may be a speaker or a display configured to output a voice or image warning. The warning may be generated, based on the TTC of the approaching objects 4 and 5 and the current distances from the approaching objects 4 and 5.

The lines indicated by ‘20’ and ‘30’ in FIG. 2 are lines set based on the TTC of the approaching objects 4 and 5 and the control unit 60 may be configured to output a warning signal, when the TTC is substantially short, that is, when the approach speeds of the approaching vehicles are substantially high. When the TTC is substantially long, that is, the approach speeds of the approaching vehicles are substantially low, the control unit 60 may be configured to output a warning signal, when the approaching objects 4 and 5 reach the line indicated by ‘20’.

The control unit 60 may be configured to determine whether the conditions for performing the method of generating a warning of a rear collision (S10), and may perform step S20, when the conditions for performing the method of generating a warning of a rear collision are satisfied. For example, when the driver inputs via a button or a voice a command to operate the system that generates a warning of a rear collision, or moves the shift lever to the reverse position in the vehicle, the control unit 60 may be configured to determine that the conditions for performing the method of generating a warning of a rear collision are satisfied.

Further, the control unit 60 may be configured to determine whether the conditions for finishing the method of generating a warning of a rear collision (S80) and then finish the method of generating a warning of a rear collision. For example, when the driver inputs a command via a button or a voice to finish the operation of the system that generates a warning of a rear collision, or moves the shift lever from the reverse gear to the neutral position or the drive position in the vehicle, the control unit 60 may be configured to determine that the conditions for finishing the method of generating a warning of a rear collision are satisfied.

The control unit 60 may not be configured to generate the warning, when the angle α formed by the path of the approaching object, which crosses the concern area 10, and the boundary 12 of the concern area is equal to or less than a predetermined angle. The angle formed by the approaching vehicle 4 and the boundary 12, which are shown in FIG. 1, is about 90°, when there is a possibility of a collision of the approaching vehicle 4 and the concern vehicle 1.

However, for example, when the approaching vehicle 4 travels with an angle of about 0 to 30° even when the vehicle is driven toward the concern area 10 of the concern vehicle 1, it may be determined that there is a low possibility of collision and a warning may not be generated. The angle may be selectively set based on the possibility of a collision and the traveling status of a vehicle.

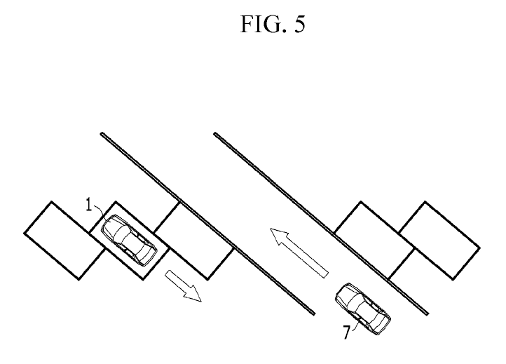

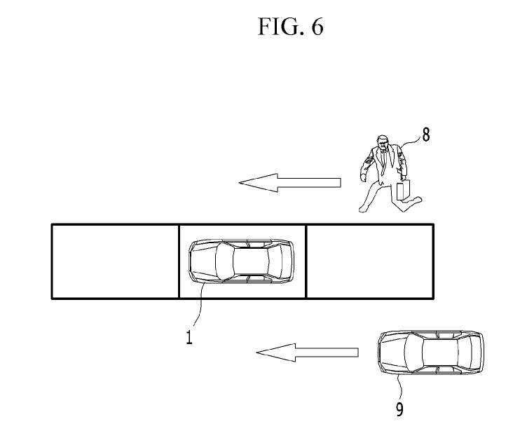

The system and method of generating a warning of a rear collision according to an exemplary embodiment of the present invention may prevent generation of unnecessary warnings, when the path of an approaching vehicle 7 is irrelevant to the path of the concern vehicle 1, as shown in FIG. 5. In addition, the system and method of generating a warning of a rear collision according to an exemplary embodiment of the present invention may prevent generation of unnecessary warnings, even when a pedestrian or a vehicle 9 approaches, as shown in FIG. 6.

While this invention has been described in connection with what is presently considered to be exemplary embodiments, it is to be understood that the invention is not limited to the disclosed embodiments. On the contrary, it is intended to cover various modifications and equivalent arrangements included within the spirit and scope of the accompanying claims.

What is claimed is:

1. A method of generating a warning of a rear collision, comprising:
setting, by a controller, a concern area around a vehicle;
measuring, by a sensor, a position and a distance of an approaching object;
storing, by the controller, the position and distance of the approaching object and determining whether the path of the approaching object crosses the boundary of the concern area, using at least two or more stored positions and distances;
calculating, by the controller, a time-to-collision of the approaching object, when the path of the approaching object crosses the boundary of the concern area; and
generating, by the controller, a warning indicating the approaching object.

2. The method of claim 1, wherein the warning is generated, based on the time-to-collision of the approaching object and the current distance of the approaching object.

3. The method of claim 2, wherein the warning is not generated, when the angle formed by the path of the approaching object, which crosses the concern area, and the boundary of the concern area is equal to or less than a predetermined angle.

4. The method of claim 1, wherein the warning is not generated, when the angle formed by the path of the approaching object, which crosses the concern area, and the boundary of the concern area is equal to or less than a predetermined angle.

5. The method of claim 1, further comprising:
determining, by the controller, whether conditions for performing the method of generating a warning of the rear collision are satisfied.

6. A system that generates a warning of a rear collision, comprising:
a sensor configured to measure the position and distance of an approaching object; and
a controller configured to:
set a concern area around a vehicle;
store the position and distance of the approaching object and determining whether the path of the approaching object crosses the boundary of the concern area, using at least two or more stored positions and distances;
calculate a time-to-collision of the approaching object, when the path of the approaching object crosses the boundary of the concern area; and
generate a warning indicating the approaching object.

7. The system of claim 6, wherein the sensor is a BSD (Blind Spot Detection system) radar or an LCA (Lane Change Assist system) radar.

8. The system of claim 6, wherein the controller is configured to output a voice or an image warning via a speaker or a display.

9. The system of claim 6, wherein the controller is configured to generate the warning based on the time-to-collision of the approaching object and the current distance of the approaching object.

10. The system of claim 6, wherein the controller is configured to determine whether conditions for generating a warning of the rear collision are satisfied.

11. A non-transitory computer readable medium containing program instructions executed by a controller, the computer readable medium comprising:
program instructions that set a concern area around a vehicle;
program instructions that control a sensor to measure a position and a distance of an approaching object;
program instructions that store the position and distance of the approaching object and determining whether the path of the approaching object crosses the boundary of the concern area, using at least two or more stored positions and distances;
program instructions that calculate a time-to-collision of the approaching object, when the path of the approaching object crosses the boundary of the concern area; and
program instructions that generate a warning indicating the approaching object.

12. The non-transitory computer readable medium of claim 11, the warning is generated, based on the time-to-collision of the approaching object and the current distance of the approaching object.

13. The non-transitory computer readable medium of claim 12, wherein the warning is not generated, when the angle formed by the path of the approaching object, which crosses the concern area, and the boundary of the concern area is equal to or less than a predetermined angle.

14. The non-transitory computer readable medium of claim 11, wherein the warning is not generated, when the angle formed by the path of the approaching object, which crosses the concern area, and the boundary of the concern area is equal to or less than a predetermined angle.

15. The non-transitory computer readable medium of claim 11, further comprising:
program instructions that determine whether conditions for performing the method of generating a warning of the rear collision are satisfied.
